(19) United States
(12) Patent Application Publication
(10) Pub. No.: US 2025/0341972 A1
(43) Pub. Date: Nov. 6, 2025

(54) WEAR LEVELING IN A ZONED NAMESPACE MEMORY SUB-SYSTEM

(71) Applicant: Micron Technology, Inc., Boise, ID (US)

(72) Inventors: Juane Li, Milpitas, CA (US); Fangfang Zhu, San Jose, CA (US)

(21) Appl. No.: 19/198,735

(22) Filed: May 5, 2025

Related U.S. Application Data
(60) Provisional application No. 63/642,166, filed on May 3, 2024.

(51) Int. Cl. G06F 3/06

(52) U.S. Cl. CPC G06F 3/0616; G06F 3/0647; G06F 3/0679

(57) ABSTRACT

A memory device comprises multiple quad-level cell (QLC) block sets and multiple single-level cell (SLC) block sets. A processing device allocates an SLC block set from the multiple SLC block sets for storing data. The allocating of the SLC block set comprises selecting the SLC block set from the multiple SLC block sets based on a program/erase cycle count of the SLC block sets. Based on detecting a migration trigger condition, the processing device allocates a QLC block set from the multiple QLC block sets to store the data and migrates the data from the SLC block set to the QLC block set. Based on migrating the data from the SLC block set to the QLC block set, the processing device releases the SLC block set.

### PRIORITY APPLICATION

This application claims the benefit of priority to U.S. Provisional Application Ser. No. 63/643,166, filed May 6, 2024, which is incorporated herein by reference in its entirety.

### TECHNICAL FIELD

Embodiments of the disclosure relate generally to memory sub-systems and, more specifically, to wear leveling in a zoned namespace (ZNS) memory sub-system.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment that includes a memory sub-system, in accordance with some embodiments of the present disclosure.

FIGS. 2A and 2B are conceptual diagrams illustrating interactions among components in the memory sub-system in performing wear leveling of a memory device in a memory sub-system, in accordance with some embodiments of the present disclosure.

FIGS. 3-4 are flow diagrams illustrating an example method for wear leveling of a memory device in a memory sub-system, in accordance with some embodiments of the present disclosure.

FIG. 5 is a block diagram of an example computer system in which embodiments of the present disclosure may operate.

### DETAILED DESCRIPTION

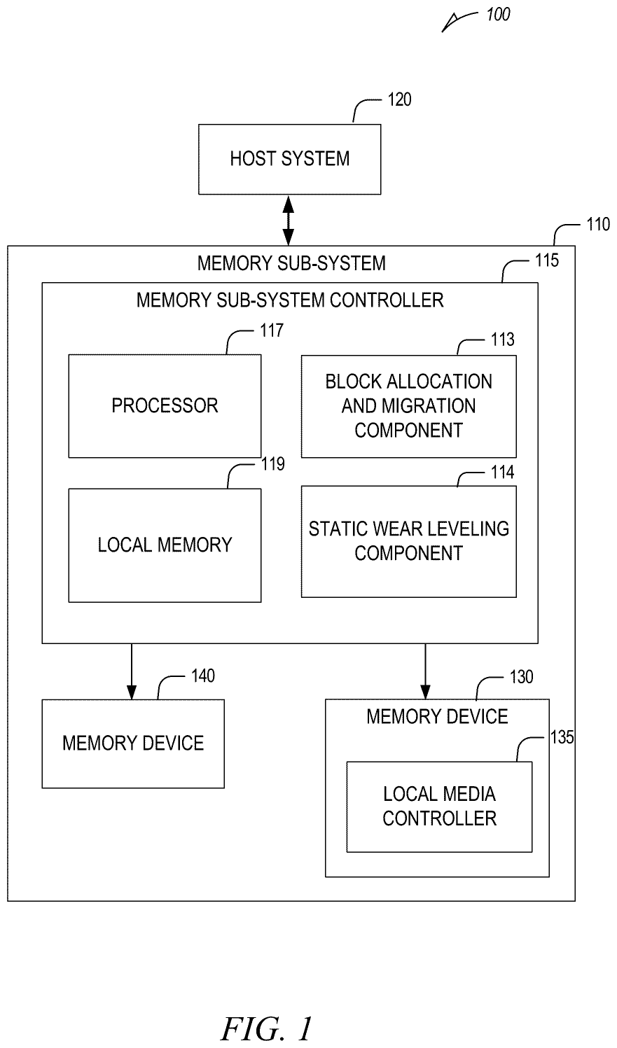

Aspects of the present disclosure are directed to wear leveling of a zoned-namespace (ZNS) memory device in a memory sub-system. In an example, the memory sub-system is a memory sub-system. A memory sub-system can be or include a memory device (e.g., SSD), a memory module, or a combination of a memory device and memory module. Examples of memory devices and memory modules are described below in conjunction with FIG. 1. In general, a host system can utilize a memory sub-system that includes one or more components, such as memory devices that store data. For example, the host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. Other examples of non-volatile memory devices are described below in conjunction with FIG. 1. A NAND memory device can include multiple NAND dies. Each die may include one or more planes and each plane includes multiple blocks. Each block includes an array that includes pages (rows) and strings (columns). A string includes a plurality of memory cells connected in a series. A memory cell (“cell”) is an electronic circuit that stores information. Depending on the cell type, a cell can store one or more bits of binary information and have various logic states that correlate to the number of bits being stored. The logic states can be represented by binary values, such as “0” and “1,” or combinations of such values.

Various memory access operations can be performed on the memory cells. Data can be written to, read from, and erased from memory cells. Memory cells can be grouped into a write unit, such as a page. For some types of memory devices, a page is the smallest write unit. A page size represents a particular number of cells of a page. For some types of memory devices (e.g., NAND), memory cells can be grouped into an erase unit, such as a block. Data can be written to a block, page-by-page. Data can be erased at a block level. However, portions of a block cannot be erased.

A Zoned Namespace (ZNS) system is a type of storage architecture used in memory sub-systems that is designed to better align with the characteristics of NAND flash memory and to improve the efficiency of storage management. In a ZNS system, the storage space is divided into zones. Each zone is a contiguous range of logical block addresses (LBAs) that is managed as a single unit. Zones are the basic units of storage management in a ZNS memory sub-system. Each zone is written sequentially, which means that new data can only be appended to the end of the current write pointer within a zone. This sequential write mechanism is in line with the way NAND memory operates, as it avoids the overhead associated with out-of-place updates and garbage collection. Each zone has an associated state machine with a set of states that define its operational characteristics. Common zone states include empty, implicitly opened, explicitly opened, closed, full, read-only, and offline.

Block sets, each of which includes a pair of blocks, are used in ZNS systems to manage the way data is stored and accessed on NAND memory within NAND memory devices. By grouping blocks into block sets, the ZNS system can more effectively manage the aforementioned variation in number and location of factory bad blocks, pairing good blocks together to increase, ideally maximize usable storage capacity and minimize the impact of bad blocks. A memory sub-system controller (also referred to herein simply as a “controller”) manages the logical to physical mapping of data, and block sets represent a logical grouping that the controller can manage more easily. For example, this logical grouping simplifies the task of tracking which blocks are in use, which are available for writing, and which need to be erased and recycled.

Wear leveling is a technique used in NAND memory devices to prolong the lifespan of NAND memory. Since NAND memory cells can only endure a limited number of program/erase (P/E) cycles before becoming unreliable, wear leveling algorithms distribute the write and erase operations evenly across the memory cells to prevent any single cell from wearing out prematurely.

In ZNS systems, wear leveling is more complex due to the zoned structure of data storage. For example, in ZNS memory devices, wear leveling must account for the sequential write nature of zones. In addition, each zone is written to and erased as a unit, which presents unique challenges for wear leveling in addressing zone states and transitions.

Aspects of the present disclosure address techniques for improving wear leveling within a ZNS memory sub-system. In an example, a memory device in a ZNS memory sub-system includes at least two types of blocks: Single-Level Cell (SLC) block sets that provide quick access and are utilized as cache for temporarily storing data that is frequently written to, and Quad-Level Cell (QLC) block sets that have a larger storage capacity suitable for the long-term retention of data. Block sets (QLC or SLC) that contain valid user data are mapped to a zone within the ZNS system and included in a mapped pool of block sets, while block sets that do not contain valid data are not mapped and are included in an unmapped pool of block sets.

A processing device in the memory sub-system (e.g., a memory sub-system controller) selects and allocates the SLC block set in the memory device with the lowest program/erase cycle count (the number of program/erase cycles performed at the SLC block set) to store data. This approach ensures that the least worn-out blocks are used first, helping to prevent any particular section of the memory device from wearing out too quickly.

The processing device monitors for a migration trigger condition that indicates it is time for moving the data from the SLC block set to a QLC block set. In an example, the migration trigger condition is based on a predetermined number of SLC block sets being fully written with data.

Based on detecting the condition, the processing device selects one or more SLC block sets for migration, selects and allocates one or more QLC block sets for storing the data, and migrates data from the one or more SLC block sets to the one or more QLC block sets. Depending on the migration scheme used by the processing device, the processing device can select the SLC block sets for migration based on: an average program/erase cycle count of the SLC block set (determined based on the program/erase cycle count of each of the pair of blocks forming the block set); an average block version of the SLC block set (determined based on the block version of each of the pair of blocks forming the block set); or a finished time associated with the SLC block set (e.g., an age of the data stored by the SLC block set). Depending on the QLC allocation scheme used by the processing device, the processing device can select QLC block sets: based on a program/erase cycle count of the QLC block sets in the unmapped pool (e.g., a number of program/erase cycles performed at a QLC block set); from a particular die of the memory device identified based on a number of unmapped SLC block sets in the die; or based on a round robin selection scheme.

After the data migration, the one or more SLC block sets are released, meaning they are marked as empty, and moved to the unmapped pool to be made available for new data. This process helps to distribute the wear evenly across the memory device, which can extend its life.

The wear leveling techniques described in the example above are also referred to as “dynamic” wear leveling techniques as these approaches adapt to usage patterns of the memory device, allowing for dynamic adjustments to wear leveling thresholds and strategies. In addition to these dynamic wear leveling techniques, the processing device can employ one or more static wear leveling techniques. For example, based on detecting an SLC static wear leveling condition based on satisfaction of a threshold condition related to a difference in program/erase cycle counts between unmapped and mapped SLC block sets, the processing device performs SLC static wear leveling. The SLC static wear leveling includes selecting a first SLC block set from the mapped pool based on the program/erase cycle count of SLC block sets in the mapped pool, selecting a second SLC block set from the unmapped pool based on the program/erase cycle count of SLC block sets in the unmapped pool, moving data stored by the first SLC block set to the second SLC block set, and moving the first SLC block set to the unmapped pool of SLC block sets.

As another example of static wear leveling, based on detecting a QLC static wear leveling condition based on satisfaction of a threshold condition related to a difference in program/erase cycle counts between unmapped and mapped QLC block sets, the processing device performs QLC static wear leveling. The QLC static wear leveling includes selecting a first QLC block set from the mapped pool based on the program/erase cycle count of QLC block sets in the mapped pool, selecting a second QLC block set from the unmapped pool based on the program/erase cycle count of QLC block sets in the unmapped pool, moving data stored by the first QLC block set to the second QLC block set, and moving the first QLC block set to the unmapped pool of QLC block sets.

The wear leveling techniques described herein extend memory device life span by reducing the likelihood of premature failure due to overused blocks. In addition, these wear leveling techniques improve memory device performance by intelligently managing the allocation of block sets, ensuring fast access to frequently used data and efficient long-term storage of less frequently accessed data. Also, these techniques minimize unnecessary write operations thereby reducing write amplification. Further, by bounding the program/erase cycle count gap among block sets, these wear leveling techniques ensure a more uniform wear level thereby improving the reliability and durability of the memory device.

FIG. 1 illustrates an example computing environment 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a USB interface, a Fibre Channel interface, a Serial Attached SCSI (SAS) interface, and so forth. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface provides physical links with multiple communication lanes (also referred to herein simply as “lanes”) for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as SLCs, multi-level cells (MLCs) (e.g., TLCs, or quad-level cells (QLCs)). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

A memory sub-system controller 115 can communicate with the memory devices 130 to perform operations such as reading data, writing data, or erasing data at the memory devices 130, and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory device 130.

The memory sub-system 110 also includes a block allocation and migration component 113 that is responsible for allocating blocks (e.g., SLC and QLC) from the memory device 130 to store user data and migrate data from SLC blocks to QLC blocks. The block allocation and migration component 113 utilizes dynamic wear leveling techniques in performing block allocation and data migration. The memory sub-system 110 further includes a static wear leveling component 114 that is responsible for performing static wear leveling on the memory device 130.

In some embodiments, the memory sub-system controller 115 includes at least a portion of the block allocation and migration component 113 and the static wear leveling component 114. For example, the memory sub-system controller 115 can include a processor 117 (processing device) configured to execute instructions stored in local memory 119 (e.g., firmware) for performing the operations described herein. In some embodiments, the block allocation and migration component 113 and the static wear leveling component 114 are part of the host system 120, an application, or an operating system. Further details regarding the operation of the block allocation and migration component 113 and the static wear leveling component 114 are discussed below.

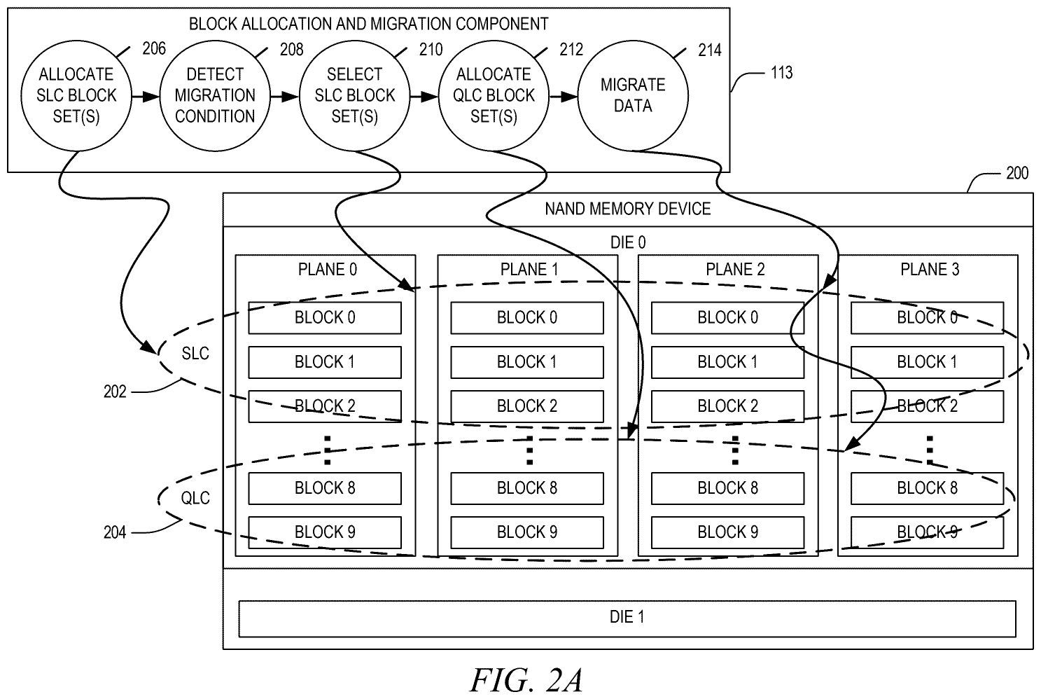

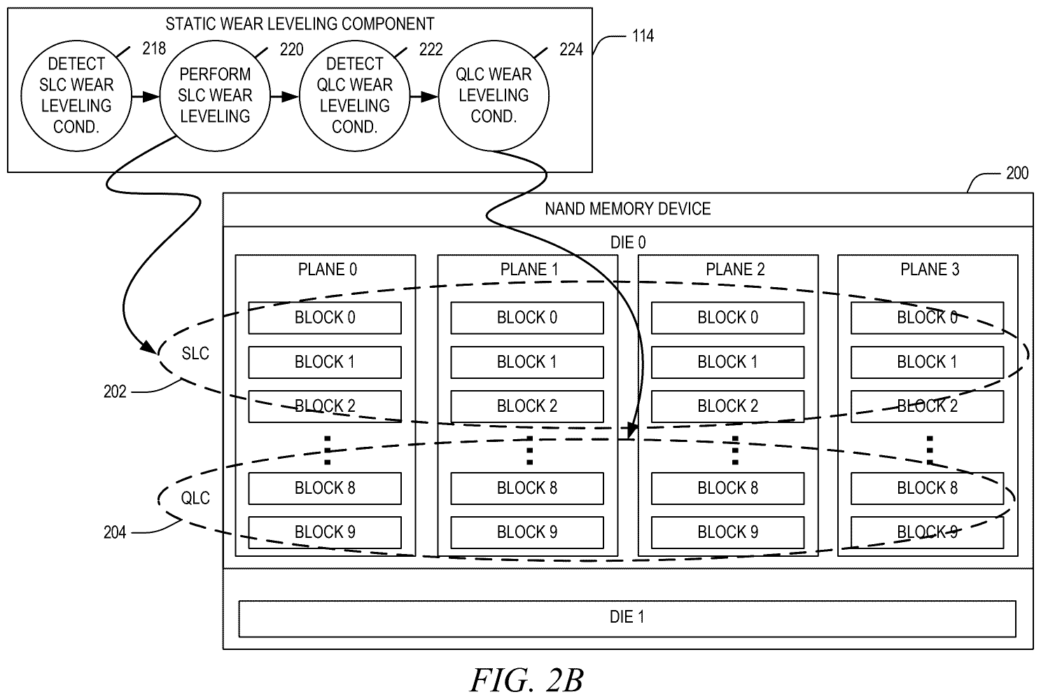

FIGS. 2A and 2B are conceptual diagrams illustrating interactions among components in the memory sub-system in performing wear leveling of a NAND memory device 200 in a memory sub-system, in accordance with some embodiments of the present disclosure. In the example illustrated in FIGS. 2A and 2B, the NAND memory device 200 is an example memory device 130. The NAND memory device 200 includes multiple NAND dies—die 0 and die 1. Each die includes multiple planes. As an example, die 0 comprises planes 0, 1, 2, and 3. Each plane includes multiple blocks. For example, as shown, each plane includes blocks 0-9 (physical block numbers). Each block includes a two- or three-dimensional array that includes pages (rows) and strings (columns). A string includes a plurality of memory cells connected in a series. Each memory cell is used to represent one or more bit values. For example, a single NAND flash cell includes a transistor that stores an electric charge on a memory layer that is isolated by oxide insulating layers above and below. Within each cell, data is stored as the Vt of the transistor. SLC NAND cells, for example, can store one bit per cell while QLC NAND cells can store four bits per cell. Other types of memory cells, such as MLCs, TLCs, QLCs, and penta-level cells (PLCs), can store multiple bits per cell.

Each plane of the NAND memory device 200 includes an SLC portion 202 having multiple SLC blocks and a QLC portion 204 having multiple QLC blocks. SLC blocks are grouped into multiple SLC block sets and QLC blocks are grouped into multiple QLC blocks.

Block sets (QLC or SLC) that contain valid user data are mapped to a zone within a ZNS system of NAND memory device 200 and are referred to as “mapped” block sets. Block sets that do not contain valid data are not mapped and are accordingly referred to as “unmapped” block sets. Mapped block sets are included in a mapped pool of block sets while unmapped block sets are included in an unmapped pool of block sets.

Each block of the NAND memory device 200 has an associated block version. The block version is an increasing counter that is incremented each time a block is open for a write operation.

With reference to FIG. 2A, in some example implementations, the block allocation and migration component 113 allocates SLC block sets (at operation 206) within the SLC portion 202 to be used as a cache to store host write data. Upon detecting a migration trigger condition (at operation 208), which is discussed in further detail below, the block allocation and migration component 113 moves data from SLC cache in the SLC portion 202 to QLC blocks in the QLC portion 204 (at operation 214).

In allocating a SLC block set (at operation 206), the block allocation and migration component 113 selects the SLC block set from the unmapped pool of SLC block sets based on a program/erase cycle count of each SLC block set. The program/erase cycle count of a given SLC block set specifies a number of program/erase cycles that have been performed at the SLC block set. In an example, the processing device selects the SLC block set from the unmapped pool of SLC block sets with the lowest program/erase cycle count. Host data may be written to the allocated SLC block set and zone mapping information for the SLC block set is updated based on host data being stored by the SLC block set thereby adding the SLC block set to the mapped pool of SLC block sets.

The block allocation and migration component 113 detects a migration trigger condition (at operation 208) when a number of fully written SLC block sets in the SLC portion 202 satisfies a threshold condition. In an example, the migration trigger condition is detected when the number of fully written SLC block sets exceeds a configurable threshold number defined by the threshold condition.

Based on detecting the migration trigger condition (at operation 208), the block allocation and migration component 113 selects one or more SLC block sets for migration (at operation 210), allocates one or more QLC block set from the unmapped pool of QLC block sets (at operation 212), and migrates data from the one or more SLC block set to the one or more QLC block set (at operation 214).

The block allocation and migration component 113 selects the SLC block sets for migration (at operation 210) based on a migration scheme. Depending on the migration scheme, the block allocation and migration component 113 can select the SLC block sets for migration based on: an average program/erase cycle count of the SLC block set (determined based on the program/erase cycle count of each of the pair of blocks forming the block set); an average block version of the SLC block set (determined based on the block version of each of the pair of blocks forming the block set); or a finished time associated with the SLC block set (e.g., an age of the data stored by the SLC block set).

In allocating QLC block sets from the unmapped pool (at operation 212), the block allocation and migration component 113 selects QLC block sets from the unmapped pool based on a QLC allocation scheme. Depending on the QLC allocation scheme, block allocation and migration component 113 can select QLC block sets: based on a program/erase cycle count of the QLC block sets in the unmapped pool (e.g., a number of program/erase cycles performed at a QLC block set); from a particular die of the memory device 200 identified based on a number of unmapped SLC block sets in the die; OR based on a round robin selection scheme.

In some implementations, a predetermined number of SLC block sets are migrated to QLC block sets at each instance of operation 212. The predetermined number of SLC block sets may, for example, correspond to the configurable threshold number defined by the threshold condition of the migration trigger condition discussed above. Consistent with some QLC allocation schemes, the block allocation and migration component 113 may select multiple QLC block sets from a single die (e.g., up to the predetermined number), one from each plane, and perform the migration of the multiple SLC block sets to the selected multiple QLC block sets.

With reference to FIG. 2B, the static wear leveling component 114 detects an SLC static wear leveling condition (operation 218). In an example, an SLC wear leveling condition is detected when a difference between the lowest program/erase cycle count in the unmapped pool of SLC block sets and the lowest program/erase cycle count in the mapped pool of SLC block sets exceeds a first threshold value. Based on detecting the SLC static wear leveling condition, the static wear leveling component 114 performs SLC static wear leveling on the memory device 200 (at operation 220).

The SLC static wear leveling includes: selecting a first SLC block from the mapped pool of SLC blocks to swap with an unmapped SLC block set from the unmapped pool (e.g., the SLC block set with the lowest program/erase cycle count from the unmapped pool of SLC block sets); selecting a second SLC block set from the unmapped pool of SLC block sets to swap with the first (mapped) SLC block set (e.g., the SLC block set with the lowest program/erase cycle count from the unmapped pool of SLC block sets); moving data stored by the first SLC block set to the second SLC block set; and moving the first SLC block set from the mapped pool of SLC block sets to the unmapped pool of SLC block sets.

The static wear leveling component 114 detects a QLC wear leveling condition, at operation 222. In an example, a QLC wear leveling condition is detected based on determining a difference between the lowest program/erase cycle count in the unmapped pool of QLC block sets and the lowest program/erase cycle count in the mapped pool of QLC blocks exceeds a second threshold value.

Based on detecting the QLC wear leveling condition, the static wear leveling component 114 performs QLC wear leveling (operation 224). The QLC static wear leveling includes: selecting a first QLC block from the mapped pool of QLC blocks to swap with an unmapped QLC block set from the unmapped pool; selecting a second QLC block set from the unmapped pool of QLC block sets to swap with the first (mapped) QLC block set; moving data stored by the first QLC block set to the second QLC block set; and moving the first QLC block set from the mapped pool of QLC block sets to the unmapped pool of QLC block sets.

The manner in which the static wear leveling component 114 selects the first and second QLC block set is based on the QLC wear leveling scheme employed by the static wear leveling component 114. Depending on the QLC wear leveling scheme, the static wear leveling component 114 may: select the QLC block set from the mapped pool of QLC block sets (the first QLC block set) with the lowest program/erase cycle count and the QLC block set from the unmapped pool of QLC block sets (the second QLC block set) with the lowest program/erase cycle count; select the (mapped) first QLC block set from a first die of the memory device and the (mapped) second QLC block from a second die of the memory device, where the first and second QLC block set satisfy the SLC static wear leveling condition; or employs a round robin selection scheme to select the first QLC block set and the second QLC block set from the same die, where the first and second QLC block set satisfy the QLC static wear leveling condition.

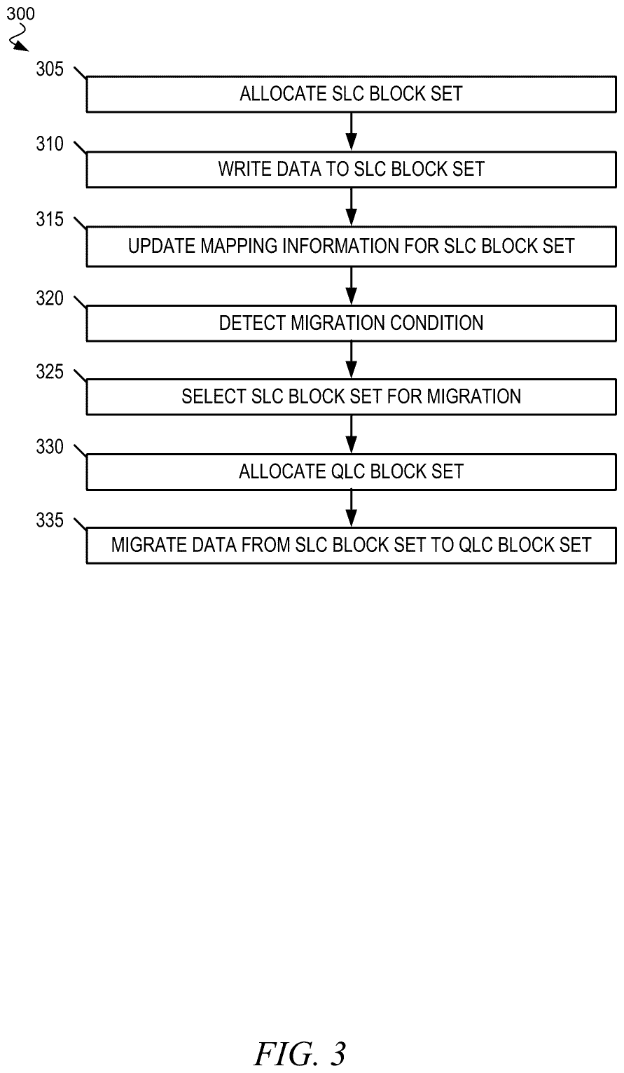

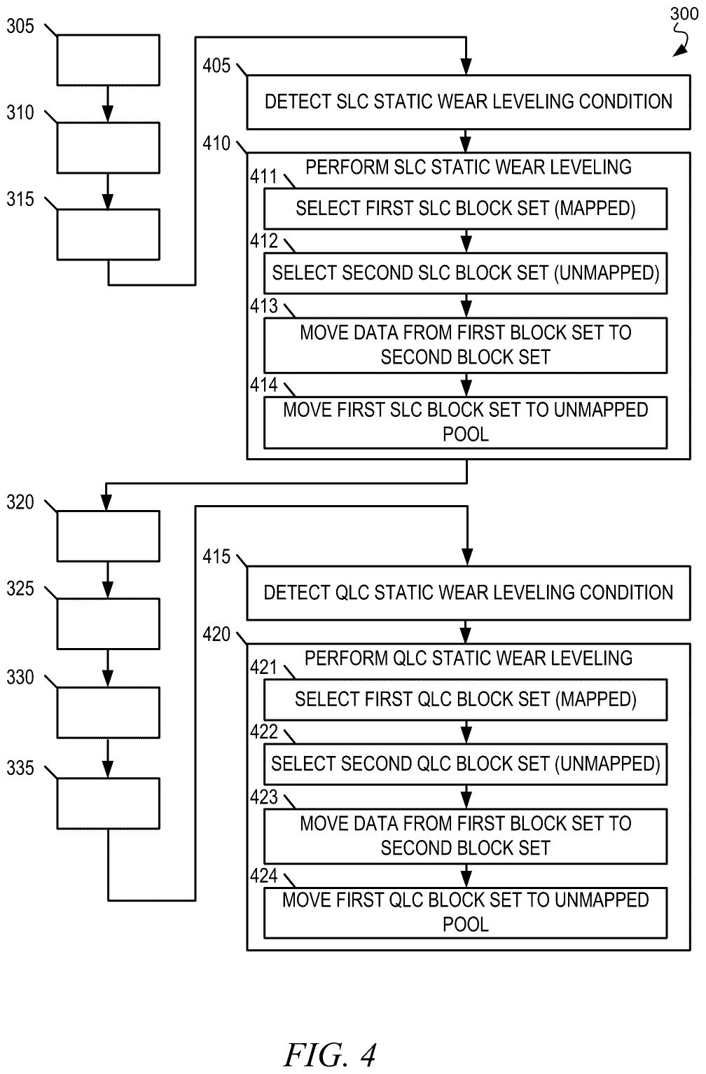

FIG. 3 and FIG. 4 are flow diagrams illustrating an example method 300 for wear leveling of a memory device in a memory sub-system, in accordance with some embodiments of the present disclosure. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, one or more operations of the method 300 are performed by the block allocation and migration component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In the example addressed by the description of the method 300 below, a ZNS memory device comprises multiple dies, each die comprises multiple planes, and each plane comprises multiple blocks. Within each plane, blocks are identified by a physical block number (e.g., block 1, block 2, block 3, and so forth). In addition, each plane includes an SLC portion having multiple SLC blocks and a QLC portion having multiple QLC blocks. Within the SLC portion, SLC blocks are grouped into multiple SLC block sets, and within the QLC portion, QLC blocks are grouped into multiple QLC blocks.

At operation 305, a processing device allocates an SLC block set from the unmapped pool of SLC block sets for storing data. In allocating the SLC block set, the processing device selects the SLC block set from the unmapped pool of SLC block sets based on a program/erase cycle count of each SLC block set. In an example, the processing device selects the SLC block set from the unmapped pool of SLC block sets with the lowest count of program erase cycles.

At operation 310, the processing device writes data to the SLC block set and based on the data being written to the SLC block set, the processing device updates the zone mapping information for the SLC block set, at operation 315. Accordingly, the SLC block set is included in the mapped pool SLC block sets based on the updating of the zone mapping information.

At operation 320, the processing device detects a migration trigger condition. In an example, the processing device detects a migration trigger condition when a number of fully written SLC block sets satisfies a threshold condition. That is, the processing device detects the migration trigger condition when the number of fully written SLC block sets exceeds a configurable threshold number defined by the threshold condition.

Based on detecting the migration trigger condition, the processing device selects the SLC block set for migration (operation 325), allocates a QLC block set from the unmapped pool of QLC block sets for storing the data (operation 330), and migrates the data from the SLC block set to the QLC block set (at operation 335).

The processing device selects the SLC block set for migration based on a migration scheme. In a first example migration scheme, the processing device selects the SLC block set for migration based on an average program/erase cycle count of the SLC block set, where the average is determined based on the program/erase cycle count of each of the pair of blocks forming the block set. The processing device may select the SLC block set for migration based on the SLC block set having the lowest average program/erase cycle count among SLC block sets in the memory device, in a particular die of the memory device, or in a particular plane of the memory device.

In a second example migration scheme, the processing device selects the SLC block set for migration based on an average block version of the SLC block set, where the average is determined based on the block version of each of the pair of blocks forming the block set. The processing device may select the SLC block set for migration based on the SLC block set having the lowest average block version among SLC block sets in the memory device, in a particular die of the memory device, or in a particular plane of the memory device.

In a third example migration scheme, the processing device selects the SLC block set for migration based on a finished time associated with the SLC block set. The finished time associated with an SLC block set indicates an age of the data stored by the SLC block set (e.g., an amount of time that has elapsed since data currently stored by the SLC block set was written to the SLC block set). In an example, the finished time associated with a block set is recorded as an increasing counter that is increased each time a block set is fully written. In this way, the counter acts as a timestamp, marking the completion of writing operations to a block set. The finished time associated with each block set in the memory device is stored in a data structure in local memory (e.g., local memory 119) of the processing device. The processing device may select the SLC block set for migration based on the data stored by the SLC block set being the oldest data (based on finished time) stored by block sets in the memory device, in a particular die of the memory device, or in a particular plane of the memory device.

In allocating the QLC block set from the unmapped pool, the processing device selects the QLC block set from the unmapped pool based on a QLC allocation scheme. In a first example QLC allocation scheme, the processing device selects the QLC block set from the unmapped pool based on a program/erase cycle count of the QLC block sets in the unmapped pool. In accordance with the first example QLC allocation scheme, the processing device identifies a set of dies within the memory device that have at least one unmapped QLC block set. From the set of dies, the processing device further identifies a subset of the set of dies that have the highest number of planes with at least one unmapped QLC block set. For each die in the subset of dies, the processing device determines a sum of lowest program/erase cycle counts based on program/erase cycle counts of the QLC block set in each plane with the lowest program/erase cycle counts. The processing device selects the die from the subset with the sum of lowest program/erase cycle counts, and the processing device selects the QLC block set from the die. More specifically, the processing device selects the QLC block set from one of the planes of the die where the QLC block set has the lowest program/erase cycle count in the plane.

In some implementations, a predetermined number of SLC block sets are migrated to QLC block sets at each instance of detecting a migration trigger condition. The predetermined number of SLC block sets may, for example, correspond to the configurable threshold number defined by the threshold condition discussed above. Consistent with the first example QLC allocation scheme, the processing device may select multiple QLC block sets from the die (e.g., up to the predetermined number), one from each plane, and perform the migration of the multiple SLC block sets to the selected multiple QLC block sets.

In a second example QLC allocation scheme, the processing device selects the QLC block set from a particular die of the memory device identified based on a number of unmapped SLC block sets in the die, and the processing device selects the QLC block set from the die based on a program/erase cycle count of QLC blocks in the die.

In a third example QLC allocation scheme, the processing device selects the QLC block set based on a round robin selection scheme.

Based on migrating the data from the SLC block set to the QLC block set, the processing device releases the SLC block set, at operation 335. In releasing the SLC block set, the processing device updates the zone mapping information for the SLC block set to indicate that the SLC block set is unmapped thereby returning the SLC block set to the unmapped pool of SLC block sets.

As shown in FIG. 4, the method 300 may, in some examples, include operations 405, 410, 415, and 420. The operations 405 and 410 may be performed at any time during the method 300, but for ease of explanation, the operations 405 and 410 are described in this example as occurring after operation 315 where the processing device updates mapping information for the SLC block set based on storing data at the SLC block set.

At operation 405, the processing device detects an SLC static wear leveling condition. In an example, an SLC wear leveling condition is detected when:

$${SLCMinPEC}_{mapped} + SLCLevelingThreshold \leq {SLCMinPEC}_{unmapped}$$

That is, in this example, the detecting of the SLC wear leveling condition includes determining a difference between the lowest program/erase cycle count in the unmapped pool of SLC block sets (SLCMinPEC_{unmapped}) and the lowest program/erase cycle count in the mapped pool of SLC block sets (SLCMinPEC_{mapped}) exceeds a threshold value (SLCLevelingThreshold).

Based on detecting the SLC static wear leveling condition, the processing device performs SLC static wear leveling on memory device, at operation 410. As shown, the SLC static wear leveling includes operations 411, 412, 413, and 414. At operation 411, the processing device selects a first SLC block set from the mapped pool of SLC block sets to swap with an unmapped SLC block set from the unmapped pool. The processing device selects the first SLC block set based on a program/erase cycle count for the first SLC block set. In an example, the processing device selects the SLC block set with the lowest program/erase cycle count from the unmapped pool of SLC block sets.

At operation 412, the processing device selects a second SLC block set from the unmapped pool of SLC block sets to swap with the first (mapped) SLC block set. The processing device selects the second SLC block set based on a program/erase cycle count for the second SLC block set. In an example, the processing device selects the SLC block set with the lowest program/erase cycle count from the unmapped pool of SLC block sets.

At operation 413, the processing device moves data stored by the first SLC block set to the second SLC block set. Based on moving the data from the first SLC block set to the second SLC block set, the processing device moves the first SLC block set from the mapped pool of SLC block sets to the unmapped pool of SLC block sets, at operation 414. In doing so, the processing device updates zone mapping information of the first SLC block set to indicate that it is unmapped.

The operations 415 and 420 may be performed at any time during the method 300, but for ease of explanation, the operations 415 and 420 are described in this example as occurring after operation 320 where the processing device migrates the data from the SLC block set to the QLC block set.

At operation 415, the processing device detects a QLC wear leveling condition. In an example, a QLC wear leveling condition is detected when:

$${QLCMinPEC}_{mapped} + QLCLevelingThreshold \leq {QLCMinPEC}_{unmapped}$$

That is, in this example, the detecting of the QLC wear leveling condition includes determining a difference between the lowest program/erase cycle count in the unmapped pool of QLC block sets (QLCMinPEC_{unmapped}) and the lowest program/erase cycle count in the mapped pool of QLC blocks (QLCMinPEC_{mapped}) exceeds a threshold value (QLCLevelingThreshold).

Based on detecting the QLC wear leveling condition, the processing device performs QLC wear leveling at operation 420. As shown, the QLC static wear leveling includes operations 421, 422, 423, and 424. At operation 421, the processing device selects a first QLC block from the mapped pool of QLC blocks to swap with an unmapped QLC block set from the unmapped pool. At operation 422, the processing device selects a second QLC block set from the unmapped pool of QLC block sets to swap with the first (mapped) QLC block set.

At operation 423, the processing device moves data stored by the first QLC block set to the second QLC block set. Based on moving the data from the first QLC block set to the second QLC block set, the processing device moves the first QLC block set from the mapped pool of QLC block sets to the unmapped pool of QLC block sets, at operation 424. In doing so, the processing device updates a zone mapping information for the first QLC block set to indicate that the first QLC block set is unmapped.

The manner in which the processing device selects the first and second QLC block set is based on a QLC wear leveling scheme employed by the processing device. In a first example QLC wear leveling scheme, the processing device selects the QLC block set from the mapped pool of QLC block sets (the first QLC block set) with the lowest program/erase cycle count and the processing device selects the QLC block set from the unmapped pool of QLC block sets (the second QLC block set) with the lowest program/erase cycle count.

In a second example QLC wear leveling scheme, the processing device selects the (mapped) first QLC block set from a first die of the memory device and the (mapped) second QLC block from a second die of the memory device, where the first and second QLC block set satisfy the SLC static wear leveling condition. In this example, the processing device identifies the mapped block set in each plane of the first die with the lowest program/erase cycle count (including the first QLC block set) and the processing device identifies the unmapped block set in each plane of the second die with the lowest program/erase cycle count (including the second QLC block set). The processing device moves the data from all identified mapped block sets in the first die to the identified unmapped block sets in the second die and the processing device moves the identified mapped block sets to the unmapped block set pool.

In a third example QLC wear leveling scheme, the processing device employs a round robin selection scheme to select the first QLC block set and the second QLC block set from the same die, where the first and second QLC block set satisfy the QLC static wear leveling condition.

Described implementations of the subject matter can include one or more features, alone or in combination as illustrated below by way of example.

Example 1. A memory sub-system comprising: a memory device comprising multiple quad-level cell (QLC) block sets and multiple single-level cell (SLC) block sets; and a processing device coupled to the memory device, the processing device to perform operations comprising: allocating an SLC block set from the multiple SLC block sets for storing data, the allocating of the SLC block set comprising selecting the SLC block set from the multiple SLC block sets based on a program/erase cycle count of the SLC block sets; detecting a migration trigger condition; based on detecting the migration trigger condition, allocating a QLC block set from the multiple QLC block sets to store the data; migrating the data from the SLC block set to the QLC block set, and based on migrating the data from the SLC block set to the QLC block set, releasing the SLC block set.

Example 2. The memory sub-system of Example 1, wherein selecting of the SLC block set comprises identifying the SLC block set as having a lowest program/erase cycle count among the multiple SLC block sets.

Example 3. The memory sub-system of any one or more of Examples 1 or 2, wherein releasing of the SLC block set comprises updating zone mapping information of the SLC block set to indicate that the SLC block set is unmapped.

Example 4. The memory sub-system of any one or more of Examples 1-3, wherein: the SLC block set is a first SLC block set; a first portion of the multiple SLC block sets form a mapped pool of SLC block sets, the mapped pool of SLC block sets comprises the first SLC block set; a second portion of the multiple SLC block sets form an unmapped pool of SLC block sets; and the operations comprise: detecting an SLC static wear leveling condition; and based on detecting the SLC static wear leveling condition, performing static wear leveling on the multiple SLC blocks, the performing of the static wear leveling comprising: identifying a second SLC block set from the unmapped pool of SLC block sets; moving the data from the first SLC block set to the second SLC block set; and moving the first SLC block set from the mapped pool of SCL block sets to the unmapped pool of SLC block sets.

Example 5. The memory sub-system of any one or more of Examples 1-4, wherein detecting the SLC wear level condition comprising determining that a difference between a lowest program/erase cycle count in mapped SLC block sets and a lowest program/erase cycle count in unmapped SLC block sets exceeds a threshold value.

Example 6. The memory sub-system of any one or more of Examples 1-5, wherein the operations comprise selecting the SLC block set for migration to the QLC block set based on one of: a program/erase cycle count of the SLC block set, a block version of the SLC block set, or a finished time of the SLC block set, the finished time indicating when the SLC block set is fully written.

Example 7. The memory sub-system of any one or more of Examples 1-6, wherein the allocating of the QLC block set comprises selecting the QLC block set from the multiple block sets.

Example 8. The memory sub-system of any one or more of Examples 1-7, wherein the selecting of the QLC block set comprises: identifying a set of dies within the memory device having at least one unmapped QLC block; determining a lowest program/erase cycle count associated with each die in the set of dies; selecting a die from the set of dies based on the lowest program/erase cycle count associated with each die; and selecting the QLC block set from a plane of the die based on the QLC block set having a lowest program/erase cycle count of QLC block sets in the plane.

Example 9. The memory sub-system of any one or more of Examples 1-8, wherein the selecting of the QLC block set comprises: determining a number of unmapped SLC block sets in each die of multiple dies of the memory device; identifying a die, from among the multiple dies, of the memory device having a lowest number of unmapped SLC block sets; and selecting the QLC block set from a plane of the die based on the QLC block set having a lowest program/erase cycle count of QLC block sets in the plane.

Example 10. The memory sub-system of any one or more of Examples 1-9, wherein selecting a die from among multiple dies of the memory device based on a round robin selection scheme; and selecting the QLC block set from a plane of the die based on the QLC block set having a lowest program/erase cycle count of QLC block set in the plane.

Example 11. The memory sub-system of any one or more of Examples 1-10, wherein the QLC block set is a first QLC block set; the operations comprise: detecting a QLC static wear leveling condition; and based on detecting the QLC wear leveling condition, performing QLC static wear leveling on the multiple QLC blocks, the performing QLC static wear leveling comprising moving the data from the first QLC block set to a second QLC block set.

Example 12. The memory sub-system of any one or more of Examples 1-11, wherein the operations comprise selecting the second QLC block based on determining the first QLC block set and the second QLC block set satisfy the QLC static wear leveling condition.

Example 13. The memory sub-system of any one or more of Examples 1-2, wherein: the first QLC block set is from a first die of the memory device; the second QLC block set is from a second die of the memory device; and the operations comprise selecting the second QLC block set from the second die based on determining the second QLC block set has a lowest program/erase cycle count of QLC block sets in the second die.

Example 14. The memory sub-system of any one or more of Examples 1-13, wherein the first QLC block set and the second QLC block set are located on a same die of the memory device.

Example 15. A method comprising: allocating, by a processing device, an SLC block set in a memory device for storing data, the allocating of the SLC block set comprising selecting the SLC block set from multiple SLC block sets of the memory device based on the SLC block set having a lowest program/erase cycle count among the multiple SLC block sets; detecting, by the processing device, a migration trigger condition; based on detecting the migration trigger condition, allocating, by the processing device, from multiple QLC block sets in the memory device, a QLC block set to store the data; migrating, by the processing device, the data from the SLC block set to the QLC block set, and based on migrating the data from the SLC block set to the QLC block set, releasing, by the processing device, the SLC block set.

Example 16. The method of Example 15, comprising selecting the SLC block set for migration to the QLC block set based on one of: a program/erase cycle count of the SLC block set, a block version of the SLC block set, or a finished time of the SLC block set, the finished time indicating when the SLC block set is fully written.

Example 17. The method of any one or more of Examples 15 or 16, wherein the allocating of the QLC block set comprises selecting the QLC block set from the multiple block sets based on at least one of: a lowest program/erase cycle count associated with each die in the memory device; a program/erase cycle count of the QLC block set; a number of unmapped SLC block sets in each die of the memory device; and a round robin selection scheme.

Example 18. A computer-readable storage medium comprising instructions that, when executed by a processing device, configure the processing device to perform operations comprising: allocating an SLC block set in a memory device for storing data, the allocating of the SLC block set comprising selecting the SLC block set from multiple SLC block sets of the memory device based on the SLC block set having a lowest a program/erase cycle count among the multiple SLC block sets; detecting a migration trigger condition; based on detecting the migration trigger condition, allocating from multiple QLC block sets in the memory device, a QLC block set to store the data; migrating the data from the SLC block set to the QLC block set, and based on migrating the data from the SLC block set to the QLC block set, releasing the SLC block set.

Example 19. The computer-readable storage medium of Example 18, wherein the operations comprise selecting the SLC block set for migration to the QLC block set based on one of: a program/erase cycle count of the SLC block set, a block version of the SLC block set, or a finished time of the SLC block set, the finished time indicating when the SLC block set is fully written.

Example 20. The computer-readable storage medium of any one or more of Examples 18 or 19, wherein the allocating of the QLC block set comprises selecting the QLC block set from the multiple block sets based on at least one of: a lowest program/erase cycle count associated with each die in the memory device; a program/erase cycle count of the QLC block set; a number of unmapped SLC block sets in each die of the memory device; and a round robin selection scheme.

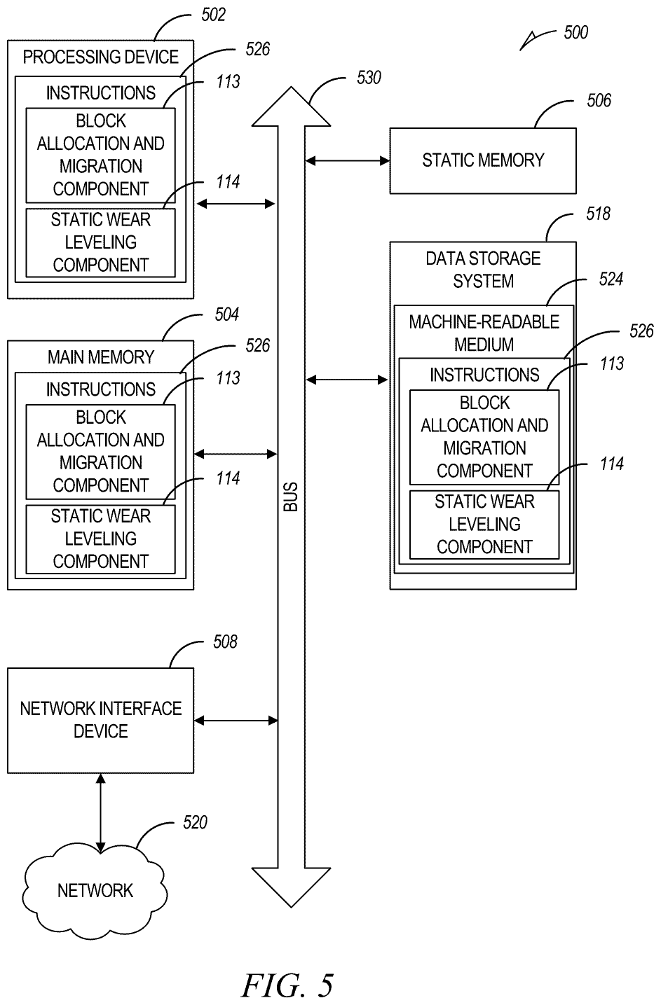

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the block allocation and migration component 113 or the static wear leveling component 114). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly executes a set (or multiple sets) of instructions to perform any one or more of the methodologies discussed herein.

The example computer system 500 includes a processing device 502, a main memory 504 (e.g., ROM, flash memory, DRAM such as SDRAM or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an ASIC, a FPGA, a digital signal processor (DSP), network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a block allocation and migration component (e.g., the block allocation and migration component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device comprising multiple quad-level cell (QLC) block sets and multiple single-level cell (SLC) block sets; and
a processing device coupled to the memory device, the processing device to perform operations comprising:
allocating an SLC block set from the multiple SLC block sets for storing data, the allocating of the SLC block set comprising selecting the SLC block set from the multiple SLC block sets based on a program/erase cycle count of the SLC block sets;
detecting a migration trigger condition;
based on detecting the migration trigger condition,
allocating a QLC block set from the multiple QLC block sets to store the data;
migrating the data from the SLC block set to the QLC block set, and
based on migrating the data from the SLC block set to the QLC block set, releasing the SLC block set.

2. The memory sub-system of claim 1, wherein selecting of the SLC block set comprises identifying the SLC block set as having a lowest program/erase cycle count among the multiple SLC block sets.

3. The memory sub-system of claim 2, wherein releasing of the SLC block set comprises updating zone mapping information of the SLC block set to indicate that the SLC block set is unmapped.

4. The memory sub-system of claim 1, wherein: the SLC block set is a first SLC block set; a first portion of the multiple SLC block sets form a mapped pool of SLC block sets, the mapped pool of SLC block sets comprises the first SLC block set;
a second portion of the multiple SLC block sets form an unmapped pool of SLC block sets; and the operations comprise:
detecting an SLC static wear leveling condition; and
based on detecting the SLC static wear leveling condition, performing static wear leveling on the multiple SLC blocks, the performing of the static wear leveling comprising:
identifying a second SLC block set from the unmapped pool of SLC block sets;
moving the data from the first SLC block set to the second SLC block set; and
moving the first SLC block set from the mapped pool of SCL block sets to the unmapped pool of SLC block sets.

5. The memory sub-system of claim 4, wherein detecting the SLC wear level condition comprising determining that a difference between a lowest program/erase cycle count in mapped SLC block sets and a lowest program/erase cycle count in unmapped SLC block sets exceeds a threshold value.

6. The memory sub-system of claim 1, wherein the operations comprise selecting the SLC block set for migration to the QLC block set based on one of: a program/erase cycle count of the SLC block set, a block version of the SLC block set, or a finished time of the SLC block set, the finished time indicating when the SLC block set is fully written.

7. The memory sub-system of claim 1, wherein the allocating of the QLC block set comprises selecting the QLC block set from the multiple block sets.

8. The memory sub-system of claim 7, wherein the selecting of the QLC block set comprises:
identifying a set of dies within the memory device having at least one unmapped QLC block;
determining a lowest program/erase cycle count associated with each die in the set of dies;
selecting a die from the set of dies based on the lowest program/erase cycle count associated with each die; and
selecting the QLC block set from a plane of the die based on the QLC block set having a lowest program/erase cycle count of QLC block sets in the plane.

9. The memory sub-system of claim 7, wherein the selecting of the QLC block set comprises:
determining a number of unmapped SLC block sets in each die of multiple dies of the memory device;
identifying a die, from among the multiple dies, of the memory device having a lowest number of unmapped SLC block sets; and
selecting the QLC block set from a plane of the die based on the QLC block set having a lowest program/erase cycle count of QLC block sets in the plane.

10. The memory sub-system of claim 7, wherein
selecting a die from among multiple dies of the memory device based on a round robin selection scheme; and
selecting the QLC block set from a plane of the die based on the QLC block set having a lowest program/erase cycle count of QLC block set in the plane.

11. The memory sub-system of claim 1, wherein the QLC block set is a first QLC block set; the operations comprise:
detecting a QLC static wear leveling condition; and
based on detecting the QLC wear leveling condition, performing QLC static wear leveling on the multiple QLC blocks, the performing QLC static wear leveling comprising moving the data from the first QLC block set to a second QLC block set.

12. The memory sub-system of claim 11, wherein the operations comprise selecting the second QLC block based on determining the first QLC block set and the second QLC block set satisfy the QLC static wear leveling condition.

13. The memory sub-system of claim 11, wherein:
the first QLC block set is from a first die of the memory device;
the second QLC block set is from a second die of the memory device; and
the operations comprise selecting the second QLC block set from the second die based on determining the second QLC block set has a lowest program/erase cycle count of QLC block sets in the second die.

14. The memory sub-system of claim 11, wherein the first QLC block set and the second QLC block set are located on a same die of the memory device.

15. A method comprising:
allocating, by a processing device, an SLC block set in a memory device for storing data, the allocating of the SLC block set comprising selecting the SLC block set from multiple SLC block sets of the memory device based on the SLC block set having a lowest program/erase cycle count among the multiple SLC block sets;
detecting, by the processing device, a migration trigger condition;
based on detecting the migration trigger condition, allocating, by the processing device, from multiple QLC block sets in the memory device, a QLC block set to store the data;
migrating, by the processing device, the data from the SLC block set to the QLC block set, and
based on migrating the data from the SLC block set to the QLC block set, releasing, by the processing device, the SLC block set.

16. The method of claim 15, comprising selecting the SLC block set for migration to the QLC block set based on one of: a program/erase cycle count of the SLC block set, a block version of the SLC block set, or a finished time of the SLC block set, the finished time indicating when the SLC block set is fully written.

17. The method of claim 15, wherein the allocating of the QLC block set comprises selecting the QLC block set from the multiple block sets based on at least one of: a lowest program/erase cycle count associated with each die in the memory device; a program/erase cycle count of the QLC block set; a number of unmapped SLC block sets in each die of the memory device; and a round robin selection scheme.

18. A computer-readable storage medium comprising instructions that, when executed by a processing device, configure the processing device to perform operations comprising:
allocating an SLC block set in a memory device for storing data, the allocating of the SLC block set comprising selecting the SLC block set from multiple SLC block sets of the memory device based on the SLC block set having a lowest a program/erase cycle count among the multiple SLC block sets;
detecting a migration trigger condition;
based on detecting the migration trigger condition, allocating from multiple QLC block sets in the memory device, a QLC block set to store the data;
migrating the data from the SLC block set to the QLC block set, and
based on migrating the data from the SLC block set to the QLC block set, releasing the SLC block set.

19. The computer-readable storage medium of claim 18, wherein the operations comprise selecting the SLC block set for migration to the QLC block set based on one of: a program/erase cycle count of the SLC block set, a block version of the SLC block set, or a finished time of the SLC block set, the finished time indicating when the SLC block set is fully written.

20. The computer-readable storage medium of claim 18, wherein the allocating of the QLC block set comprises selecting the QLC block set from the multiple block sets based on at least one of: a lowest program/erase cycle count associated with each die in the memory device; a program/erase cycle count of the QLC block set; a number of unmapped SLC block sets in each die of the memory device; and a round robin selection scheme.
